(19) United States
(12) Patent Application Publication
(10) Pub. No.: US 2007/0058101 A1
(43) Pub. Date: Mar. 15, 2007

(54) Liquid crystal display device

(76) Inventors: Masahiro Kawasaki, Tsukuba (JP); Takeo Shiba, Kodaira (JP); Shuji Imazeki, Hitachi (JP); Masahiko Ando, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/510,561

(22) Filed: Aug. 28, 2006

(30) Foreign Application Priority Data
Sep. 5, 2005 (JP) 2005-255805

(51) Int. Cl. G02F 1/136; G02F 1/1337

(52) U.S. Cl. 349/43; 349/123

(57) ABSTRACT

It is an object of the present invention to prevent degradation of an organic semiconductor film caused in forming an alignment layer and to inexpensively provide a liquid crystal display device with a high-performance organic thin film transistor. According to the invention, in a liquid crystal display device that includes: a thin film transistor substrate having such members as a thin film transistor composed of a gate electrode, a gate insulating film, source/drain electrodes, and a semiconductor layer, a line, and a pixel electrode; and an opposing substrate supporting a liquid crystal layer between the thin film transistor substrate and the opposing substrate, no alignment layer having a function of controlling alignment of molecules in the liquid crystal layer is interposed between the semiconductor layer and the liquid crystal layer.

### BACKGROUND OF THE INVENTION

(1) Field of the Invention

The present invention relates to a liquid crystal display device using a thin film transistor.

(2) Description of Related Art

With the evolution of computerization, emphasis has been on the development of a thin and lightweight electronic paper display in place of a piece of paper, an IC tag enabling instantaneous identification of one product from another, and the like. At present, a thin film transistor, which uses amorphous silicon or polysilicon for its semiconductor, is used as a switching element in such devices. Fabricating a thin film transistor using silicon semiconductor, however, imposes equipment costs such as of expensive plasma chemical vapor deposition (CVD) and sputtering tools, and even has a problem of low production efficiency due to a number of processes that are gone through, such as a vacuum process, a photolithography, and other fabrication processes.

For this reason, attention has recently been focused on an-organic thin film transistor that uses in its semiconductor layer an organic material, which can be formed by coating or printing and can make it possible to inexpensively provide a product. For a display using an organic thin film transistor as a switching element for a pixel, JP-A-10-209459 (Patent Document 1) discloses a structure in a cross-section of a liquid crystal display. As disclosed in the document, an alignment layer for inducing alignment of a liquid crystal layer is formed after a thin film transistor, which is composed of such members as a gate electrode, a gate insulating film, a semiconductor layer, a source electrode and a drain electrode, is formed on an insulating substrate, and therefore, this results in a structure having a thin film transistor also covered with the alignment layer. This applies whether the semiconductor in the thin film transistor is organic or inorganic.

The alignment layer is formed by applying polyimide solved in a high-boiling solvent (boiling point: 204° C.) consisting primarily of γ-butyrolactone, and then baking it on the order of 230° C. Therefore, when an organic compound is used for a semiconductor layer in the thin film transistor while forming the alignment layer after the thin film transistor is formed, as with a conventional practice, causes the semiconductor layer to be agglomerated by heat, posing a problem of performance degradation of the thin film transistor. To address this problem, it is conceivable that the polyimide is baked at a low temperature on the order of 80° C. to avoid degradation of the semiconductor layer. In this case, however, there is a problem of a high-boiling solvent for the polyimide remaining in the polyimide film, which in turn infiltrates into the organic semiconductor, degrading the organic semiconductor performance. Interposing a protective layer between the organic semiconductor and the alignment layer may have the effect of reducing infiltration of the solvent into the organic semiconductor: however, this cannot completely prevent degradation of the organic semiconductor caused by the solvent. Particularly when the protective layer is formed by coating or printing, the effect of reducing infiltration of the solvent is diminished due to low film density of the protective layer.

### SUMMARY OF THE INVENTION

It is an object of the present invention to prevent degradation of an organic semiconductor film caused in forming an alignment layer and to inexpensively provide a liquid crystal display device with an organic thin film transistor.

In order to achieve the object, the present invention provides a liquid crystal display device including: a pair of substrates; a thin film transistor formed on one of the substrates and having a gate electrode, a gate insulating layer, a source electrode, a drain electrode, and a semiconductor layer; a pixel electrode formed on the one of the substrates; a common electrode formed on the other of the substrates; a liquid crystal layer supported between the pair of substrates; a first alignment layer disposed between the liquid crystal layer and the pixel electrode; and a second alignment layer disposed between the liquid crystal layer and the other of the substrates, wherein the semiconductor layer of the thin film transistor is formed of an organic compound, and wherein the first alignment layer is formed in a planar region other than an upper area of the semiconductor layer.

Further, the present invention provides a liquid crystal display device including: a pair of substrates; a thin film transistor formed on one of the substrates and having a gate electrode, a gate insulating layer, a source electrode, a drain electrode, and a semiconductor layer; a pixel electrode formed on the one of the substrates; a common electrode formed on the other of the substrates; a liquid crystal layer supported between the pair of substrates; and a second alignment layer disposed between the liquid crystal layer and the other of the substrates, wherein the semiconductor layer of the thin film transistor is formed of an organic compound, and wherein the gate insulating layer is formed of a plurality of films laminated together, one of the plurality of layers contacts the semiconductor layer above the gate electrode, and the one of the plurality of layers is disposed on the pixel electrode and has a function of controlling alignment of liquid crystal molecules in the liquid crystal layer.

Further, the present invention provides a liquid crystal display device including: a pair of substrates; a thin film transistor formed on one of the substrates and having a gate electrode, a gate insulating layer, a source electrode, a drain electrode, and a semiconductor layer; a pixel electrode formed on the one of the substrates; a common electrode formed on the other of the substrates; a liquid crystal layer supported between the pair of substrates; a first alignment layer disposed between the liquid crystal layer and the pixel electrode; and a second alignment layer disposed between the liquid crystal layer and the other of the substrates, wherein the semiconductor layer of the thin film transistor is formed of an organic compound, and wherein a film of the same material as the first alignment layer is formed between the semiconductor layer and the gate insulating layer.

Further, the present invention provides a liquid crystal display device including: a pair of substrates; a thin film transistor formed on one of the substrates and having a gate electrode, a gate insulating layer, a source electrode, a drain electrode, and a semiconductor layer; a common electrode formed on the other of the substrates; a liquid crystal layer supported between the pair of substrates; a first alignment layer disposed between the liquid crystal layer and the one of the substrates; and a second alignment layer disposed between the liquid crystal layer and the other of the substrates, wherein the semiconductor layer of the thin film transistor is formed of an organic compound, and wherein the source electrode of the thin film transistor has a function of pixel electrode and is disposed between the one of the substrates and the first alignment layer, and the first alignment layer is formed in a planar region other than an upper area of the semiconductor layer.

The present invention may prevent degradation of an organic semiconductor film caused in forming an alignment layer and inexpensively provide a liquid crystal display device with an organic thin film transistor.

Other objects, features and advantages of the invention will become apparent from the following description of the embodiments of the invention taken in conjunction with the accompanying drawings.

### BRIEF DESCRIPTION OF THE DRAWINGS

FIG. 1 shows an arrangement and a schematic plan view of an example of a liquid crystal display device according to the invention;

FIG. 2 shows a structure in a cross-section of a thin film transistor according to the invention;

FIG. 3 shows a structure in a plan view of a pixel portion according to the invention;

FIG. 4 shows another structure in a cross-section of a thin film transistor according to the invention;

FIG. 5 shows yet another structure in a cross-section of a thin film transistor according to the invention;

FIG. 6 shows yet another structure in a cross-section of a thin film transistor according to the invention;

FIG. 7 shows yet another structure in a cross-section of a thin film transistor according to the invention; and

FIG. 8 shows yet another structure in a cross-section of a thin film transistor according to the invention.

### DESCRIPTION OF SYMBOLS

101, 101′ . . . INSULATING SUBSTRATE, 102 . . . GATE ELECTRODE, 102′ . . . SCAN LINE, 103, 401 . . . PIXEL ELECTRODE, 104 . . . COMMON LINE, 105, 301 . . . GATE INSULATING LAYER, 106, 106′, 202 . . . THROUGH HOLE, 107, 402 . . . ALIGNMENT LAYER, 108 . . . DRAIN ELECTRODE, 108′ . . . SIGNAL LINE, 109 . . . SOURCE ELECTRODE, 110 . . . SEMICONDUCTOR LAYER, 111 . . . PROTECTIVE FILM, 112 . . . COMMON ELECTRODE, 113 . . . BLACK MATRIX, 114 . . . COLOR FILTER, 115 . . . LIQUID CRYSTAL LAYER, 201 . . . GATE INSULATING LAYER, 302 . . . FILM FOR IMPROVING THE ELECTRON FIELD-EFFECT MOBILITY

### DETAILED DESCRIPTION OF THE INVENTION

Hereafter, examples of the invention will now be described in detail with reference to the drawing.

### EXAMPLE 1

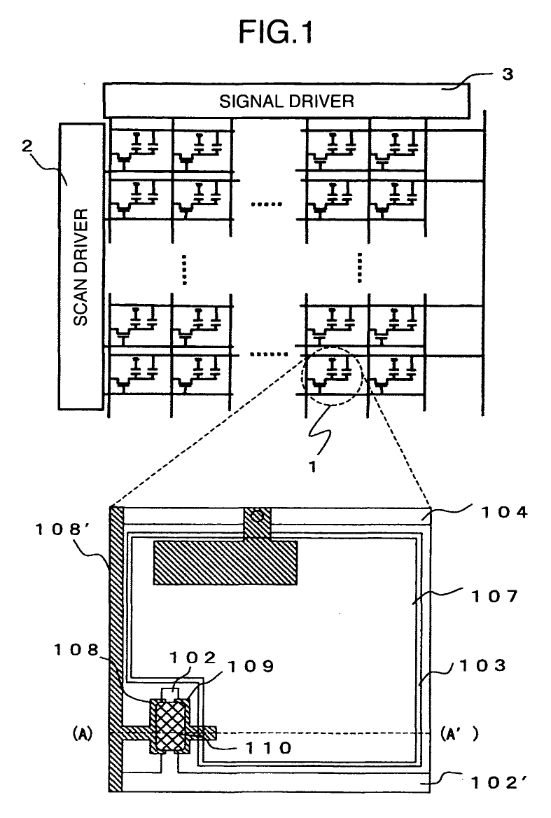

FIG. 1 shows an example of an arrangement and a schematic plan view of a liquid crystal display device according to the invention.

There are disposed in a matrix multiple pixels 1 arranged in rows and columns, a scan line 102′ for use in selecting a pixel in a predetermined cycle, and a signal line 108′ for providing information to the pixel. Each scan line is connected to a scan driver 2. In addition, each signal line is connected to a signal driver 3. As an example, a pixel in mth row and nth column is operated during one cycle as follows: when the scan line in the nth column connected to the pixel is selected, a predetermined voltage is applied to the gate electrode of a thin film transistor (TFT) of the pixel in the nth column, which turns on the transistor. At this time, brightness information, or a signal voltage Vs=Vdmn, is captured from the signal line in the mth row, and is applied to the drain electrode of the pixel in the mth row and nth column. Even after the scan line in the nth column connected to the pixel is deselected, the brightness information is retained in the pixel capacitor for a predetermined period of time.

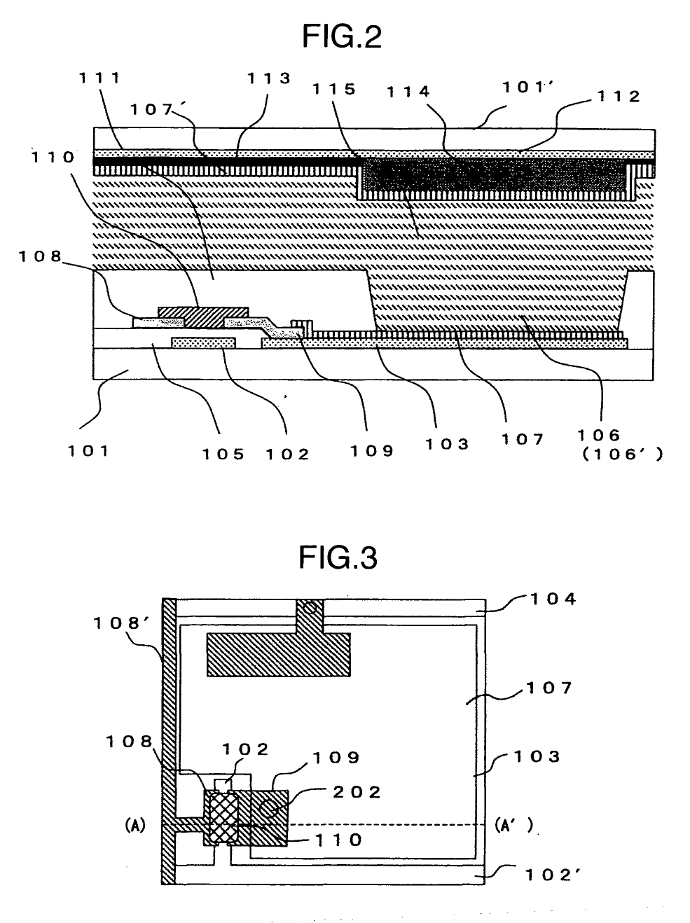

FIG. 2 shows a schematic cross-section of a pixel portion in the liquid crystal display device according to the invention.

FIG. 2 relates to a cross-section taken along line (A)-(A)′ of FIG. 1. The description will be made with reference to FIGS. 1 and 2.

A TFT substrate was first fabricated according to the procedure as described below. An insulating substrate 101 used a glass substrate. The insulating substrate 101 may be selected from a wide variety of insulating materials. Specifically, the substrate may use an inorganic substrate such as of quartz, sapphire, or silicon; a substrate of aluminum, stainless steel, or the like coated with an insulating film; or an organic plastic substrate such as of acryl, epoxy, polyamide, polycarbonate, polyimide, polyester, polynorbornene, polyphenylene oxide, polyethylene naphthalene dicarboxylate, polyethylene terephthalate, polyethylene naphthalate, polyallylate, polyetherketone, polyethersulfone, polyketone, or polyphenylene sulfide. A substrate provided with a film such as of silicon oxide or silicon nitride on the surface thereof may also be used. An ITO film sputtered thereon was patterned by photolithography to form a gate electrode 102 and a scan line 102′, a pixel electrode 103, as well as a common line 104, all having a thickness of 150 nm in the same layer. The gate electrode 102, scan line 102′, pixel electrode 103, and common line 104 may be any conductor without limitation, and may use, for example, a metal or alloy such as Al, Cu, Ti, Cr, Au, Ag, Ni, Pd, Pt, Ta, or Mo; a silicon material such as single crystal silicon or polysilicon; a transparent conductive material such as ITO or IZO; an organic conductor such as polyaniline or poly-3,4-ethylenedioxythiophene/polystyrene sulfonate; or the like, and may be formed by a known method such as plasma CVD, thermal deposition, sputtering, screen printing, ink jetting, electrolytic polymerization, electroless plating, electroplating, or hot stamping. Besides a single layer structure, the gate electrode may have a stacked structure of multiple layers, for example, a combination of a Cr layer and an Au layer, a combination of a Ti layer and a Pt layer, or the like. The gate electrode 102, scan line 102′, pixel electrode 103, and common line 104 may also be formed into a desired shape by photolithography, shadow masking, microprinting, laser abrasion, and the like. Additionally, the gate electrode 102, scan line 102′, pixel electrode 103, and common line 104 may be formed of any materials different from each other.

Spin-coated polysilazane was then baked at 450° C., and a SiO2 film having a thickness of 200 nm was used for a gate insulating layer 105. An inorganic film such as of silicon nitride, aluminum oxide, or tantalum oxide; an organic film such as of polyvinylphenol, polyvinyl alcohol, polyimide, polyamic acid, polyamide, parylene, polymethyl methacrylate, polyvinyl chloride, polyacrylonitrile, poly(perfluoroethylene-co-butenyl vinyl ether), polyisobutylene, poly(4-methyl-1-pentene), poly(propylene-co-(1-butene)), or a benzocyclobutene resin; or a laminated film thereof may be used for the gate insulating layer 105, which may be formed by plasma CVD, thermal deposition, sputtering, anodic oxidation, spray coating, spin coating, dip coating, roll coating, blade coating, doctor roll coating, screen printing, ink jetting, and the like. A through hole 106 was formed by photolithography so that the gate insulating film over the pixel electrode was removed. When the gate insulating layer 105 is formed by printing as described above, the through hole 106 can be formed concurrently with the gate insulating layer 105.

A polyimide film was then formed to a thickness of 50 nm by spin coating, baked at 200° C., and thereafter patterned by photolithography so that the pixel electrode was covered, to form an alignment layer 107. Besides polyimide, the alignment layer 107 may use polyamic acid or a film consisting of polyimide and polyamic acid, as well as a resin material such as acryl, polychloropyrene, polyethylene terephthalate, polyoxymethylene, polyvinyl chloride, polyvinylidene fluoride, cyanoethylpullulan, polymethyl methacrylate, polysulfone, or polycarbonate. When the same material is used for both the gate insulating layer 105 and alignment layer 107, the number of processes may be reduced because the gate insulating film and alignment layer can be concurrently formed.

An ITO film having a thickness of 150 nm was then formed by sputtering and patterned by photolithography to form a drain electrode 108, a source electrode 109, and a signal line 108′, and the source electrode 109 was connected to the pixel electrode 103. As with the gate electrode, the materials for the drain electrode 108, source electrode 109, and signal line 108′ may be any conductor without limitation, and may use, for example, a metal such as Al, Cu, Ti, Cr, Au, Ag, Ni, Pd, Pt, or Ta; a transparent conductive material such as IZO; an organic conductor such as polyaniline or poly-3,4-ethylenedioxythiophene/polystyrene sulfonate; or the like and may be formed by a known method such as plasma CVD, thermal deposition, sputtering, screen printing, ink jetting, electrolytic polymerization, electroless plating, electroplating, or hot stamping. Besides a single layer structure, the drain electrode 108, source electrode 109, and signal line 108′ may have a stacked structure of multiple layers. The drain electrode 108, source electrode 109, and signal line 108′ may also be formed into a desired shape by photolithography, shadow masking, microprinting, laser abrasion, and the like. Additionally, the drain electrode 108, source electrode 109, and signal line 108′ may be of any materials different from each other.

The top of the gate insulating layer 105 was then modified by a monomolecular film of octadecyltrichlorosilane. The monomolecular film may use a silane compound such as heptafluoroisopropoxypropylmethyldichlorosilane, trifluoropropylmethyldichlorosilane, hexamethyldisilazane, vinyltriethoxysilane, γ-methacryloxypropyltrimethoxysilane, γ-aminopropyltriethoxysilane, N-phenyl-γ-aminopropyltrimethoxysilane, γ-mercaptopropyltrimethoxysilane, heptadecafluoro-1,1,2,2-tetrahydrodecyl-1-trimethoxysilane, octadecyltriethoxysilane, decyltrichlorosilane, decyltriethoxysilane, or phenyltrichlorosilane; a phosphonic acid compound such as 1-phosphonooctane, 1-phosphonohexane, 1-phosphonohexadecane, 1-phosphono-3,7,11,15-tetramethylhexadecane, 1-phosphono-2-ethylhexane, 1-phosphono-2,4,4-trimethylpentane, or 1-phosphono-3,5,5-trimethylhexane; or the like. The modification is achieved by bringing the surface of the gate insulating layer 105 into contact with a solution or vapor of the compound to cause the compound to be adsorbed to the surface of the gate insulating film. Alternatively, the surface of the gate insulating layer 105 may not necessarily be modified by a monomolecular film.

A soluble pentacene derivative was then patterned by contact printing and baked at 150° C. to form a semiconductor layer 110 composed of an organic compound, having a thickness of 100 nm. The semiconductor layer 110 may use a phthalocyanine compound such as copper phthalocyanine, lutetium bisphthalocyanine, or aluminum phthalocyanine chloride; a condensed polycyclic aromatic compound such as tetracene, a chrysene, pentacene, pyrene, perylene, or coronene; a conjugated polymer such as polyaniline, polythienylenevinylene, poly(3-hexylthiophene), poly(3-butylthiophene), poly(3-decylthiophene), poly(9,9-dioctylfluorene), poly(9,9-dioctylfluorene-co-benzothiadiazole), or poly(9,9-dioctylfluorene-co-dithiophene); or the like, and may be formed by thermal deposition, molecular beam epitaxy, spray coating, spin coating, roll coating, blade coating, doctor roll coating, screen printing, ink jetting, and the like. When a low molecular weight organic semiconductor such as pentacene is used for the semiconductor layer 110, a gate insulating film portion in contact with the semiconductor layer is not subjected to rubbing in order to maintain smoothness of an interface between the semiconductor and the gate insulating film and improve the electron field-effect mobility of the thin film transistor.

When a liquid crystalline material such as poly-9,9-dioctylfluorene-co-dithiophene (F8T2) is used for the semiconductor layer 110, the surface of the gate insulating film in contact with the semiconductor layer may in advance be subjected to a photo-alignment process in the direction from where the source electrode is formed toward where the drain electrode is formed or in the direction from where the drain electrode is formed toward where the source electrode is formed, before the semiconductor layer is formed, to uniaxially orient the liquid crystal semiconductor in the direction of carriers moving through a channel, so that the electron field-effect mobility of thin film transistor may be improved.

A parylene film was then formed by CVD, and a protective film 111 having a thickness of 500 nm and a through hole 106′ were formed by photolithography. The protective film 111 is not limited to parylene, and may use an inorganic film such as of silicon oxide or silicon nitride; an organic film such as of polyvinylphenol, polyvinyl alcohol, polymethyl methacrylate, polyvinyl chloride, or polyacrylonitrile; or a laminated film thereof, and may be formed by plasma CVD, thermal deposition, sputtering, anodic oxidation, spray coating, spin coating, roll coating, blade coating, doctor roll coating, screen printing, ink jetting, and the like.

The alignment layer 107 was then subjected to rubbing so that liquid crystal was aligned in the diagonal direction of the insulating substrate 101 to complete the TFT substrate. Because the rubbing direction for the alignment layer depends mainly on the viewing angle of the liquid crystal, alignment directions of the alignment layer and the surface of the gate insulating film are not necessarily coincident with each other when a liquid crystalline material is used and an alignment process is performed on the surface of the gate insulating film in contact with the semiconductor layer.

An opposing substrate was fabricated according to the procedure as described below.

An insulating substrate 101′ used a glass substrate. As with the TFT substrate, the insulating substrate 101′ may be selected from a wide variety of insulating materials.

An ITO film having a thickness of 150 nm was formed on the insulating substrate 101′ by sputtering and a common line 112 was formed.

A Cr film having a thickness of 100 nm was then formed and a black matrix 113 by photolithography.

After a color filter 114 was formed, a polyimide film was formed to a thickness of 50 nm by spin coating and baked at 200° C. to form an alignment layer 107′.

The alignment layer 107′ was then subjected to rubbing to complete the opposing substrate.

A polymer spacer agent having a grain size of 5 μm is spread on the TFT substrate, and thereafter a UV curing sealer is applied on the periphery of the display portion by a dispenser. After the TFT substrate and opposing substrate are bonded together, ultraviolet light is radiated to cure the sealer. Finally, a liquid crystal layer 115 is enclosed to complete the liquid crystal panel.

As shown in the example, the alignment layer 107 is formed earlier than the semiconductor layer 110 so that the alignment layer is not disposed above the semiconductor layer 110; in other words, there is provided a structure including: insulating substrates 101 and 101′, or a pair of substrates; a thin film transistor formed on one of the substrates (insulating substrate 101) and having a gate electrode, a gate insulating layer, a source electrode, a drain electrode, and a semiconductor layer 110; a pixel electrode 103 formed on the one of the substrates; a common electrode 112 formed on the other of the substrates (insulating substrate 101′); a liquid crystal layer 115 supported between the pair of substrates; a first alignment layer (alignment layer 107) disposed between the liquid crystal layer 115 and the pixel electrode 103; and a second alignment layer (alignment layer 107′) disposed between the liquid crystal layer 115 and the other of the substrates, wherein the semiconductor layer 110 of the thin film transistor is formed of an organic compound, and wherein the first alignment layer is formed in a planar region other than an upper area of the semiconductor layer 110: this can prevent degradation of the organic semiconductor layer due to a baking temperature for the first alignment layer, or alignment layer 107, or due to a solvent for the alignment layer 107.

In addition, the alignment layer and the gate insulating film are formed in the same layer, so that the alignment layer and the gate insulating film may be formed in the same process, advantageously providing an inexpensive liquid crystal display device.

The electron field-effect mobility of the TFT fabricated in the example was not less than 2 orders of magnitude larger than that of a TFT fabricated in conventional processes, which would form an alignment layer on the TFT substrate later than the semiconductor layer, and a value of approximately 1.2 cm2/Vs was obtained.

### EXAMPLE 2

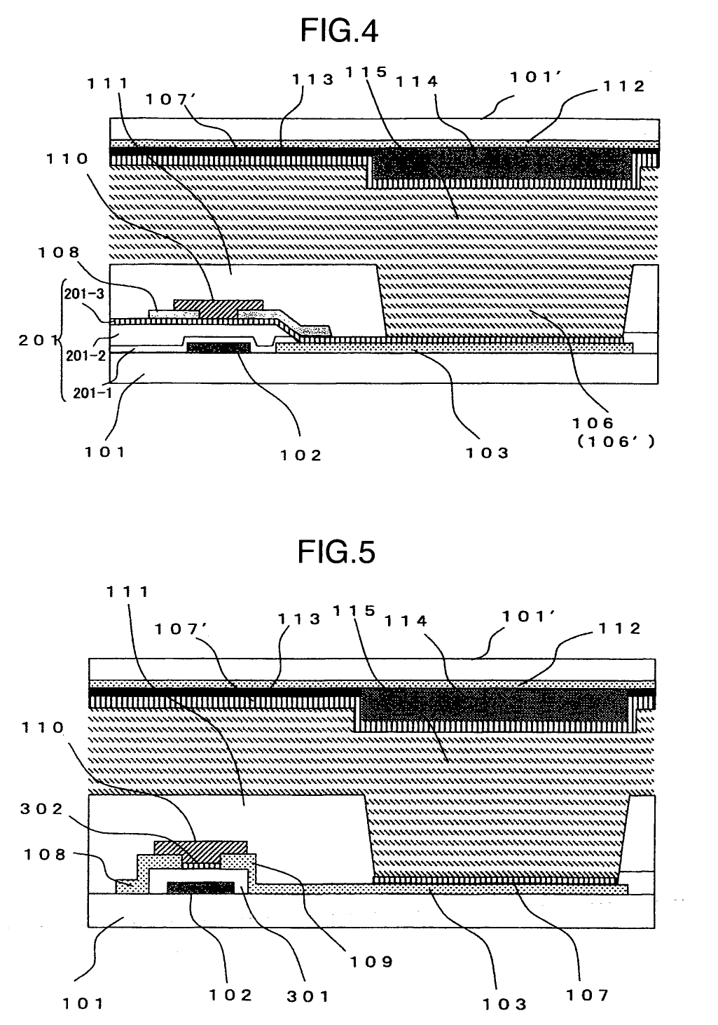

A second example of the invention will now be described with reference to FIGS. 3 and 4. FIG. 3 shows a schematic plan view of a pixel portion in a liquid crystal display device according to the invention, and FIG. 4 shows a schematic cross-section taken along line (A)-(A)′ of FIG. 3.

A TFT substrate was fabricated according to the procedure as described below. An insulating substrate 101 used a glass substrate. As with Example 1, the insulating substrate 101 may be selected from a wide variety of materials. An ITO film sputtered thereon was patterned by photolithography to form a gate electrode 102 and a scan line 102′, a pixel electrode 103, as well as a common line 104, all having a thickness of 150 nm in the same layer. The materials for the gate electrode 102, scan line 102′, pixel electrode 103, and common line 104 may be selected from a wide variety of conductors without limitation as with Example 1. They may be formed by a known method such as plasma CVD, thermal deposition, sputtering, screen printing, ink jetting, electrolytic polymerization, electroless plating, electroplating, or hot stamping. The gate electrode 102, scan line 102′, pixel electrode 103, and common line 104 may also be formed into a desired shape by photolithography, shadow masking, microprinting, laser abrasion, and the like. Additionally, the gate electrode 102, scan line 102′, pixel electrode 103, and common line 104 may be formed of any materials different from each other.

Polysilazane was then applied by dip coating to a thickness of 5 nm, and thereafter baked at 90° C. to metamorphose into a SiO2 film, forming a first layer of a gate insulating film 201 (gate insulating film 201-1). The first layer of the gate insulating film 201 may use an inorganic film such as of silicon nitride, aluminum oxide, or tantalum oxide; an organic film such as of polyvinylphenol, polyvinyl alcohol, parylene, polymethyl methacrylate, polyvinyl chloride, polyacrylonitrile, poly(perfluoroethylene-co-butenyl vinyl ether), polyisobutylene, poly(4-methyl-1-pentene), poly(propylene-co-(1-butene)), or a benzocyclobutene resin; or a laminated film thereof, and may be formed by plasma CVD, thermal deposition, sputtering, anodic oxidation, spray coating, spin coating, dip coating, roll coating, blade coating, doctor roll coating, screen printing, ink jetting, and the like. The first layer of the gate insulating film 201 may particularly use a material exhibiting better resistance to voltage and less polarization, such as SiO2, SiN, Al2O3, or Ta2O5, to improve performance of the thin film transistor.

A through hole 106 was formed by photolithography so that the gate insulating film over the pixel electrode 103 was removed. When the first layer of the gate insulating film 201 is formed by printing as described above, the through hole 106 can be formed concurrently with the first layer of the gate insulating film 201.

Polyvinylphenol was spin-coated to a thickness of 100 nm to form a second layer of the gate insulating film 201 (gate insulating film 201-2). The second layer of the gate insulating film 201 may use an inorganic film such as of silicon nitride, aluminum oxide, or tantalum oxide; an organic film such as of polyvinyl alcohol, parylene, polymethyl methacrylate, polyvinyl chloride, polyacrylonitrile, poly(perfluoroethylene-co-butenyl vinyl ether), polyisobutylene, poly(4-methyl-1-pentene), poly(propylene-co-(1-butene)), or a benzocyclobutene resin; or a laminated film thereof, and may be formed by plasma CVD, thermal deposition, sputtering, anodic oxidation, spray coating, spin coating, dip coating, roll coating, blade coating, doctor roll coating, screen printing, ink jetting, and the like.

A through hole 106′ is again formed by photolithography. When the second layer of the gate insulating film 201 is formed by printing as described above, the through hole 106′ can be formed concurrently with the second layer of the gate insulating film 201.

A polyimide film was formed to a thickness of 50 nm by spin coating and baked at 200° C. to form a third layer of the gate insulating film 201 (gate insulating film 201-3). Besides polyimide, the third layer of the gate insulating film 201 may use polyamic acid or a film consisting of polyimide and polyamic acid, as well as a resin material such as acryl, polychloropyrene, polyethylene terephthalate, polyoxymethylene, polyvinyl chloride, polyvinylidene fluoride, cyanoethylpullulan, polymethyl methacrylate, polysulfone, or polycarbonate. As shown in FIG. 3, a through hole 202 for connecting the pixel electrode 103 to the source electrode was formed by photolithography. When the third layer of the gate insulating film 201 is formed by printing as described above, the through hole 202 can be formed concurrently with the third layer of the gate insulating film 201.

The third layer of the gate insulating film was formed so that the pixel electrode 103 was also covered. The second layer of the gate insulating film may be omitted by securing resistance to voltage of the first layer of the gate insulating film. Alternatively, the first and second layers of the gate insulating film may be omitted by thickening the polyimide layer of the gate insulating film to on the order of 200 nm to 500 nm: in other words, only the third layer of the gate insulating film may be formed.

A sputtered ITO film having a thickness of 150 nm was then patterned by photolithography to form a drain electrode 108, a source electrode 109, and a signal line 108′, and the source electrode 109 was connected to the pixel electrode 103. The materials for the drain electrode 108, source electrode 109, and signal line 108′ may be selected from a wide variety of conductors without limitation as with Example 1. They may be formed by a known method such as plasma CVD, thermal deposition, sputtering, screen printing, ink jetting, electrolytic polymerization, electroless plating, electroplating, or hot stamping. Besides a single layer structure, the drain electrode 108, source electrode 109, and signal line 108′ may have a stacked structure of multiple layers. The drain electrode 108, source electrode 109, and signal line 108′ may also be formed into a desired shape by photolithography, shadow masking, microprinting, laser abrasion, and the like. Additionally, the drain electrode 108, source electrode 109, and signal line 108′ may be of any materials different from each other.

A soluble pentacene derivative was then patterned by contact printing and baked at 150° C. to form a semiconductor layer 110 having a thickness of 100 nm. The material for the semiconductor layer 110 may be selected from a wide variety of semiconductors without limitation as with Example 1. It may be formed by thermal deposition, molecular beam epitaxy, spray coating, spin coating, roll coating, blade coating, doctor roll coating, screen printing, ink jetting, and the like. When a low molecular weight organic semiconductor such as pentacene is used for the semiconductor layer 110, a gate insulating film portion in contact with the semiconductor layer is not subjected to rubbing in order to maintain smoothness of an interface between the semiconductor and the gate insulating film and improve the electron field-effect mobility of the thin film transistor.

When a liquid crystalline semiconductor such as poly-9,9-dioctylfluorene-co-dithiophene (F8T2) is used for the semiconductor layer 110, the surface of the gate insulating film in contact with the semiconductor layer may in advance be subjected to a photo-alignment process in the direction from where the source electrode is formed toward where the drain electrode is formed or in the direction from where the drain electrode is formed toward where the source electrode is formed, to uniaxially orient the liquid crystal semiconductor in the direction of carriers moving through a channel, so that the electron field-effect mobility of the thin film transistor may be improved.

A parylene film was then formed by CVD, and a protective film 111 having a thickness of 500 nm and a through hole 106′ were formed by photolithography. The protective film 111 is not limited to parylene, and may be selected from insulators as with Example 1. It may be formed by plasma CVD, thermal deposition, sputtering, anodic oxidation, spray coating, spin coating, roll coating, blade coating, doctor roll coating, screen printing, ink jetting, and the like.

Finally, the gate insulating film 201 over the pixel was then subjected to rubbing to complete the TFT substrate. Because the rubbing direction for the alignment layer depends mainly on the viewing angle of the liquid crystal, alignment directions of the alignment layer and the surface of the gate insulating film are not necessarily coincident with each other when a liquid crystalline material is used and an alignment process is performed on the surface of the gate insulating film in contact with the semiconductor layer.

As described above, there is provided a structure in which the semiconductor layer 110 of the thin film transistor is formed of an organic compound, and in which the gate insulating layer 201 is formed of a plurality of films laminated together, one of the plurality of layers contacts the semiconductor layer 110 above the gate electrode 102, and the one of the plurality of layers is disposed on the pixel electrode 103 and has a function of controlling alignment of liquid crystal molecules in the liquid crystal layer 115: this can prevent degradation of the organic semiconductor layer, while the gate insulating film having a function of alignment layer may be formed in one process, advantageously providing an inexpensive liquid crystal display device, as with Example 1.

The fabrication of an opposing substrate and enclosing of the liquid crystal layer 115 was accomplished in the same way as Example 1.

As with Example 1, the electron field-effect mobility of the TFT fabricated in the example is advantageously improved comparing to that of a TFT fabricated in conventional processes, which form an alignment layer on the TFT substrate later than the semiconductor layer.

### EXAMPLE 3

A third example of the invention will now be described with reference to FIG. 5. FIG. 5 shows a schematic cross-section of an organic thin film transistor according to the invention.

A TFT substrate was fabricated according to the procedure as described below. An insulating substrate 101 used a glass substrate. As with Example 1, the insulating substrate 101 may be selected from a wide variety of materials. An Al film sputtered thereon was patterned by photolithography to form a gate electrode 102 and a scan line 102′, as well as a common line 104, all having a thickness of 300 nm in the same layer. The materials for the gate electrode 102, scan line 102′, pixel electrode 103, and common line 104 may be selected from a wide variety of conductors without limitation as with Example 1. They may be formed by a known method such as plasma CVD, thermal deposition, sputtering, screen printing, ink jetting, electrolytic polymerization, electroless plating, electroplating, or hot stamping. The gate electrode 102, scan line 102′, and common line 104 may also be formed into a desired shape by photolithography, shadow masking, microprinting, laser abrasion, and the like. Additionally, the gate electrode 102, scan line 102′, pixel electrode-103, and common line 104 may be formed of any materials different from each other.

Anodic oxidized Al2O3 having a thickness of 200 nm was formed on the gate electrode 102, scan line 102′, and common line 104 to use as a gate insulating layer 301. The gate insulating layer 301 may be selected from a wide variety of materials as with Example 1. It may be formed by plasma CVD, thermal deposition, sputtering, anodic oxidation, spray coating, spin coating, dip coating, roll coating, blade coating, doctor roll coating, screen printing, ink jetting, and the like.

A sputtered ITO film having a thickness of 150 nm was then patterned by photolithography to form a drain electrode 108, a source electrode 109, a signal line 108′, and pixel electrode 103. In the example, the source electrode 109 and the pixel electrode 103 are integrated. The materials for the drain electrode 108, source electrode 109, and signal line 108′ may be selected from a wide variety of conductors without limitation as with Example 1. They may be formed by a known method such as plasma CVD, thermal deposition, sputtering, screen printing, ink jetting, electrolytic polymerization, electroless plating, electroplating, or hot stamping. Besides a single layer structure, the drain electrode 108, source electrode 109, and signal line 108′ may have a stacked structure of multiple layers.

The drain electrode 108, source electrode 109, and signal line 108′ may also be formed into a desired shape by photolithography, shadow masking, microprinting, laser abrasion, and the like. Additionally, the drain electrode 108, source electrode 109, and signal line 108′ may be of any materials different from each other.

A polyimide film was then formed to a thickness of 50 nm by spin coating and baked at 200° C., and thereafter patterned by photolithography so that the pixel electrode 103 was covered, forming an alignment layer 107, and while at the same time, a film 302 for improving the electron field-effect mobility was formed so that the gap between the drain electrode 108 and the source electrode 109 was filled. The alignment layer 107 was subjected to a photo-alignment process so that liquid crystal was aligned in the diagonal direction of the insulating substrate 101. On the other hand, the film 302 for improving the electron field-effect mobility was subjected to a photo-alignment process so that a liquid crystal semiconductor, which would be formed later, would be aligned in the direction from the source electrode toward the drain electrode. The rubbing direction for the alignment layer depends mainly on the viewing angle of the liquid crystal.

A liquid crystalline semiconductor may be uniaxially oriented in the direction from the source electrode toward the drain electrode, which is the direction of carriers moving through a channel, to improve the electron field-effect mobility of the thin film transistor. Therefore, the directions, in which the alignment layer 107 and the film 302 for improving the electron field-effect mobility are subjected to alignment process, are not necessarily coincident with each other.

The ink jetting is then used to pattern F8T2 to form a semiconductor layer 110 having a thickness of 100 nm. The material for the semiconductor layer 110 may be selected from a wide variety of semiconductors without limitation as with Example 1. It may be formed by thermal deposition, molecular beam epitaxy, spray coating, spin coating, roll coating, blade coating, doctor roll coating, screen printing, contact printing, and the like.

A parylene film was then formed by CVD, and a protective film 111 having a thickness of 500 nm and a through hole 106′ were formed by photolithography. The protective film 111 is not limited to parylene, and may be selected from insulators as with Example 1. It may be formed by plasma CVD, thermal deposition, sputtering, anodic oxidation, spray coating, spin coating, roll coating, blade coating, doctor roll coating, screen printing, ink jetting, and the like.

In this way, the TFT substrate was completed. The fabrication of an opposing substrate-and enclosing of the liquid crystal layer 115 was accomplished in the same way as Example 1.

As described above, the example provides a structure in which a film (the film 302 for improving the electron field-effect mobility) of the same material as the first alignment layer, or the alignment layer 107, is formed between the semiconductor layer 110 and the gate insulating layer 301.

As with Example 1, the electron field-effect mobility of the TFT fabricated in the example is advantageously improved comparing to that of a TFT fabricated in conventional processes, which form an alignment layer on the TFT substrate later than the semiconductor layer.

In addition, the alignment layer 107 and the film 302 for improving the electron field-effect mobility can be concurrently fabricated, so that the number of processes may be reduced to advantageously provide an inexpensive liquid crystal display device.

### EXAMPLE 4

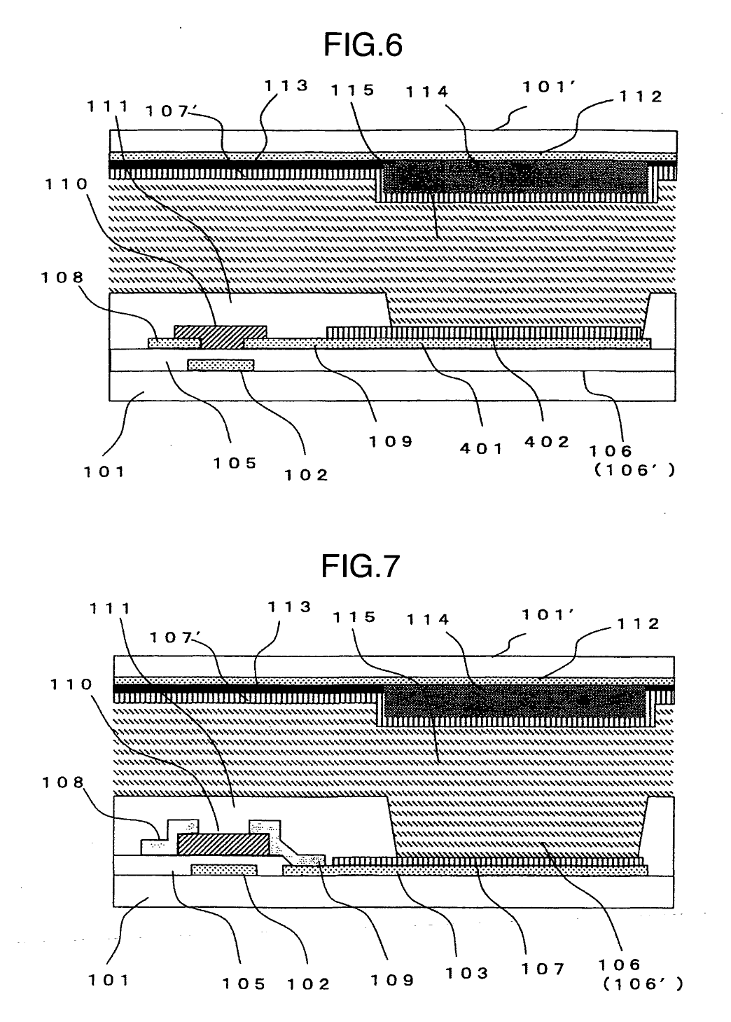

A fourth example of the invention will now be described with reference to FIG. 6. FIG. 6 shows a schematic cross-section of an organic thin film transistor according to the invention.

An insulating substrate 101, a gate electrode 102, a scan line 102′, a common line 104, a gate insulating layer 105, a through hole 106, a drain electrode 108, a source electrode 109, a signal line 108′, a semiconductor layer 110, and a protective film 111 are formed in the same way as Example 1.

The pixel electrode 401 was formed by extending the source electrode 109 to the through hole 106, and formed in the same layer as the drain electrode 108 and signal line 108′ by patterning a sputtered ITO film having a thickness of 150 nm by photolithography. The materials for the pixel electrode 401 may be any conductor without limitation, and may use, for example, a metal such as Al, Cu, Ti, Cr, Au, Ag, Ni, Pd, Pt, or Ta; other transparent conductive materials such as IZO; an organic conductor such as polyaniline or poly-3,4-ethylenedioxythiophene/polystyrene sulfonate; or the like and may be formed by a known method such as plasma CVD, thermal deposition, sputtering, screen printing, ink jetting, electrolytic polymerization, electroless plating, electroplating, or hot stamping.

Besides a single layer structure, the pixel electrode 401 may have a stacked structure of multiple layers. It may be formed into a desired shape by photolithography, shadow masking, microprinting, laser abrasion, and the like. Additionally, the pixel electrode 401 may be of any materials different from each of the drain electrode 108, source electrode 109, and signal line 108′.

After the pixel electrode 401 was formed, an alignment layer 402 was formed by using spin coating to form a polyimide film to a thickness of 50 nm, baking it at 200° C., and thereafter patterning it by photolithography so that the pixel electrode was covered. At this time, the alignment layer 402 was formed to expose the semiconductor layer 110 as with Examples 1 and 3. Besides polyimide, the alignment layer 402 may use polyamic acid or a film consisting of polyimide and polyamic acid, as well as a resin material such as acryl, polychloropyrene, polyethylene terephthalate, polyoxymethylene, polyvinyl chloride, polyvinylidene fluoride, cyanoethylpullulan, polymethyl methacrylate, polysulfone, or polycarbonate.

In this way, the TFT substrate was completed. The fabrication of an opposing substrate and enclosing of the liquid crystal layer was accomplished in the same way as Example 1.

In the invention, therefore, there is provided a structure in which the source electrode 109 of the thin film transistor has a function of a pixel electrode 401 and is disposed between the one insulating substrate 101 and the alignment layer 402, and the alignment layer 402 is formed in a planar region other than an upper area of the semiconductor layer 110: this can prevent degradation of the organic semiconductor layer, while a source electrode and a pixel electrode may be formed in one process, advantageously providing an inexpensive liquid crystal display device through simple manufacturing processes.

As with Example 1, the electron field-effect mobility of the TFT fabricated in the example is advantageously improved comparing to that of a TFT fabricated in conventional processes, which form an alignment layer on the TFT substrate later than the semiconductor layer.

### EXAMPLE 5

A fifth example of the invention will now be described with reference to FIG. 7. FIG. 7 shows a schematic cross-section of a pixel portion in the liquid crystal display device according to the invention.

A TFT substrate was fabricated according to the procedure as described below. An insulating substrate 101 used a glass substrate. As with Example 1, the insulating substrate 101 may be selected from a wide variety of materials. An ITO film sputtered thereon was patterned by photolithography to form a gate electrode 102 and a scan line 102′, a pixel electrode 103, as well as a common line 104, all having a thickness of 150 nm in the same layer. The materials for the gate electrode 102, scan line 102′, pixel electrode 103, and common line 104 may be selected from a wide variety of conductors without limitation as with Example 1. They may be formed by a known method such as plasma CVD, thermal deposition, sputtering, screen printing, ink jetting, electrolytic polymerization, electroless plating, electroplating, or hot stamping. The gate electrode 102, scan line 102′, pixel electrode 103, and common line 104 may also be formed into a desired shape by photolithography, shadow masking, microprinting, laser abrasion, and the like. Additionally, the gate electrode 102, scan line 102′, pixel electrode 103, and common line 104 may be formed of any materials different from each other.

Spin-coated polysilazane was then baked at 450° C., and a SiO2 film having a thickness of 200 nm was used for a gate insulating layer 105. The gate insulating layer 105 may be selected from a wide variety of insulators without limitation as with Example 1, and may be formed by plasma CVD, thermal deposition, sputtering, anodic oxidation, spray coating, spin coating, dip coating, roll coating, blade coating, doctor roll coating, screen printing, ink jetting, and the like.

A through hole 106 was formed by photolithography so that the gate insulating film over the pixel electrode 103 was removed. When the gate insulating layer 105 is formed by printing as described above, the through hole 106 can be formed concurrently with the gate insulating layer 105.

A polyimide film was then formed to a thickness of 50 nm by spin coating, baked at 200° C., and thereafter patterned by photolithography so that the pixel electrode 103 was covered, to form an alignment layer 107. Besides polyimide, the alignment layer 107 may be selected from a wide variety of resin materials as with Example 1. When the same material is used for both the gate insulating layer 105 and alignment layer 107, the number of processes may be reduced because the gate insulating film and alignment layer can be concurrently formed.

The top of the gate insulating layer 105 was then modified by a monomolecular film of octadecyltrichlorosilane. The monomolecular film may be selected from a wide variety of materials as with Example 1. The modification is achieved by bringing the surface of the gate insulating layer 105 into contact with a solution or vapor of the compound to cause the compound to be adsorbed to the surface of the gate insulating film. Alternatively, the surface of the gate insulating layer 105 may not necessarily be modified by a monomolecular film.

A soluble pentacene derivative was then patterned by contact printing and baked at 150° C. to form a semiconductor layer 110 having a thickness of 100 nm. The semiconductor layer 110 may be selected from semiconductor materials of a wide variety of organic compounds as with Example 1, and may be formed by thermal deposition, molecular beam epitaxy, spray coating, spin coating, roll coating, blade coating, doctor roll coating, screen printing, ink jetting, and the like. When a low molecular weight organic semiconductor such as pentacene is used for the semiconductor layer 110, a gate insulating film portion in contact with the semiconductor layer is not subjected to rubbing in order to maintain smoothness of an interface between the semiconductor and the gate insulating film and improve the electron field-effect mobility of the thin film transistor.

When a liquid crystalline material such as poly-9,9-dioctylfluorene-co-dithiophene (F8T2) is used for the semiconductor layer 110, the surface of the gate insulating film in contact with the semiconductor layer may in advance be subjected to a photo-alignment process in the direction from where the source electrode is formed toward where the drain electrode is formed or in the direction from where the drain electrode is formed toward where the source electrode is formed, before the semiconductor layer is formed, to uniaxially orient the liquid crystal semiconductor in the direction of carriers moving through a channel, so that the electron field-effect mobility of thin film transistor may be improved.

Masked deposition was then used to form an ITO film having a thickness of 150 nm, which was in turn shaped into a drain electrode 108, a source electrode 109, and a signal line 108′, and the source electrode 109 was connected to the pixel electrode 103. As with the gate electrode, the materials for the drain electrode 108, source electrode 109, and signal line 108′ may be any conductor without limitation, and may be selected from a wide variety of conductive materials as with Example 1. Besides a single layer structure, they may have a stacked structure of multiple layers. Additionally, the drain electrode 108, source electrode 109, and signal line 108′ may be of any materials different from each other.

A parylene film was then formed by CVD, and a protective film 111 having a thickness of 500 nm and a through hole 106′ were formed by photolithography. The protective film 111 is not limited to parylene, and may be selected from insulators as with Example 1. It may be formed by plasma CVD, thermal deposition, sputtering, anodic oxidation, spray coating, spin coating, roll coating, blade coating, doctor roll coating, screen printing, ink jetting, and the like.

The alignment layer 107 was then subjected to rubbing so that liquid crystal was aligned in the diagonal direction of the insulating substrate 101 to complete the TFT substrate. Because the rubbing direction for the alignment layer depends mainly on the viewing angle of the liquid crystal, alignment directions of the alignment layer and the surface of the gate insulating film are not necessarily coincident with each other when a liquid crystal semiconductor is used and an alignment process is performed on the surface of the gate insulating film in contact with the semiconductor layer.

The fabrication of an opposing substrate and enclosing of the liquid crystal layer was accomplished in the same way as Example 1.

As with Example 1, the electron field-effect mobility of the TFT fabricated in the example is advantageously improved comparing to that of a TFT fabricated in conventional processes, which form an alignment layer on the TFT substrate later than the semiconductor layer.

The example replaces a thin film transistor having a bottom-contact structure with that having a top-contact structure by inverting the order of formation of the source/drain electrodes and the semiconductor layer in Example 1. The same advantages may be achieved when the thin film transistors in Examples 2 to 4 is converted to those having the top-contact structure.

### EXAMPLE 6

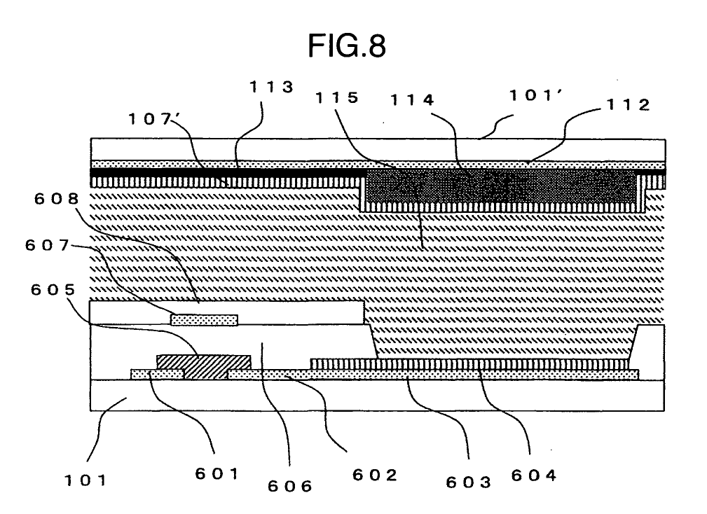

A sixth example of the invention will now be described with reference to FIG. 8. FIG. 8 shows a schematic cross-section of a pixel portion in the liquid crystal display device according to the invention.

A TFT substrate was fabricated according to the procedure as described below. An insulating substrate 101 used a glass substrate. As with Example 1, the insulating substrate 101 may be selected from a wide variety of materials. An ITO film sputtered thereon was patterned by photolithography to form a drain electrode 601, a signal line, a source electrode 602, and a pixel electrode 603, all having a thickness of 150 nm in the same layer.

A polyimide film was then formed to a thickness of 50 nm by spin coating, baked at 200° C., and thereafter patterned by photolithography so that the pixel electrode was covered, to form an alignment layer 604. Besides polyimide, the alignment layer 604 may be selected from a wide variety of resin materials as with Example 1.

A soluble pentacene derivative was then patterned by contact printing and baked at 150° C. to form a semiconductor layer 605 having a thickness of 100 nm. The semiconductor layer 605 may be selected from semiconductor materials of a wide variety of organic compounds as with Example 1, and may be formed by thermal deposition, molecular beam epitaxy, spray coating, spin coating, roll coating, blade coating, doctor roll coating, screen printing, ink jetting, and the like.

A polyvinylphenol film having a thickness of 500 nm was formed by screen printing to form a gate insulating film 606. The gate insulating film 606 is not limited to polyvinylphenol, and may be selected from insulators as with Example 1. It may be formed by plasma CVD, thermal deposition, sputtering, anodic oxidation, spray coating, spin coating, roll coating, blade coating, doctor roll coating, screen printing, ink jetting, and the like.

The alignment layer 604 was then subjected to rubbing.

Masked deposition was then used to form an Al film having a thickness of 150 nm, and a gate electrode 607 and a scan line, as well as a common line were formed. The materials for the gate electrode 607, scan line, and common line may be selected from a wide variety of conductors without limitation as with Example 1. Additionally, the gate electrode 607, scan line, and common line may be formed of any materials different from each other.

A polyvinylphenol film having a thickness of 500 nm was formed by screen printing to form a protective film 608. The protective film 608 is not limited to polyvinylphenol, and may be selected from insulators as with Example 1. It may be formed by plasma CVD, thermal deposition, sputtering, anodic oxidation, spray coating, spin coating, roll coating, blade coating, doctor roll coating, screen printing, ink jetting, and the like.

In this way, the TFT substrate was completed. The fabrication of an opposing substrate and enclosing of the liquid crystal layer 115 was accomplished in the same way as Example 1.

Accordingly, in the example, there is provided a structure including: a pair of substrates (insulating substrates 101 and 101′); a thin film transistor formed on one of the substrates (insulating substrate 101) and having a source electrode 602, a drain electrode 601, a semiconductor layer 605, a gate insulating layer 606, and a gate electrode 607; a common electrode 112 formed on the other of the substrates (insulating substrate 101′); a liquid crystal layer 115 supported between the pair of substrates; a first alignment layer (alignment layer 604) disposed between the liquid crystal layer and the one of the substrates; and a second alignment layer (alignment layer 107′) disposed between the liquid crystal layer and the other of the substrates, wherein the semiconductor layer 605 is formed of an organic compound, and wherein the source electrode 602 of the thin film transistor has a function of a pixel electrode 603 and is disposed between the one of the substrates 101 and the alignment layer 604, and the alignment layer 604 is formed in a planar region other than an upper area of the semiconductor layer 605: this can prevent degradation of the organic semiconductor layer, while a source electrode and a pixel electrode may be formed in one process, advantageously providing an inexpensive liquid crystal display device through simple manufacturing processes.

The difference between the example and Example 4 in FIG. 6 is that the layered structure of the thin film transistor is inverted, and in the example, the gate insulating film 606 is formed over the semiconductor layer 605, and a gate electrode 607 is further formed thereon.

As with Example 1, the electron field-effect mobility of the TFT fabricated in the example is advantageously improved comparing to that of a TFT fabricated in conventional processes, which form an alignment layer on the TFT substrate later than the semiconductor layer.

It should be further understood by those skilled in the art that although the foregoing description has been made on embodiments of the invention, the invention is not limited thereto and various changes and modifications may be made without departing from the spirit of the invention and the scope of the appended claims.

1. A liquid crystal display device comprising:
a pair of substrates;
a thin film transistor formed on one of the pair of substrates and having a gate electrode, a gate insulating layer, a source electrode, a drain electrode, and a semiconductor layer;
a pixel electrode formed on the one of the substrates;
a common electrode formed on the other of the substrates;
a liquid crystal layer supported between the pair of substrates;
a first alignment layer disposed between the liquid crystal layer and the pixel electrode; and
a second alignment layer disposed between the liquid crystal layer and the other of the substrates,
wherein the semiconductor layer of the thin film transistor is formed of an organic compound, and
wherein the first alignment layer is formed in a planar region other than an upper area of the semiconductor layer.

2. A liquid crystal display device comprising:
a pair of substrates;
a thin film transistor formed on one of the pair of substrates and having a gate electrode, a gate insulating layer, a source electrode, a drain electrode, and a semiconductor layer;
a pixel electrode formed on the one of the substrates;
a common electrode formed on the other of the substrates;
a liquid crystal layer supported between the pair of substrates; and
a second alignment layer disposed between the liquid crystal layer and the other of the substrates,
wherein the semiconductor layer of the thin film transistor is formed of an organic compound, and
wherein the gate insulating layer is formed of a plurality of films laminated together, one of the plurality of layers contacts the semiconductor layer above the gate electrode, and the one of the plurality of layers is disposed on the pixel electrode and has a function of controlling alignment of liquid crystal molecules in the liquid crystal layer.

3. A liquid crystal display device comprising:
a pair of substrates;
a thin film transistor formed on one of the pair of substrates and having a gate electrode, a gate insulating layer, a source electrode, a drain electrode, and a semiconductor layer;
a pixel electrode formed on the one of the substrates;
a common electrode formed on the other of the substrates;
a liquid crystal layer supported between the pair of substrates;
a first alignment layer disposed between the liquid crystal layer and the pixel electrode; and
a second alignment layer disposed between the liquid crystal layer and the other of the substrates,
wherein the semiconductor layer of the thin film transistor is formed of an organic compound, and
wherein a film of the same material as the first alignment layer is formed between the semiconductor layer and the gate insulating layer.

4. A liquid crystal display device comprising:
a pair of substrates;
a thin film transistor formed on one of the pair of substrates and having a gate electrode, a gate insulating layer, a source electrode, a drain electrode, and a semiconductor layer;
a common electrode formed on the other of the substrates;
a liquid crystal layer supported between the pair of substrates;
a first alignment layer disposed between the liquid crystal layer and the one of the substrates; and
a second alignment layer disposed between the liquid crystal layer and the other of the substrates,
wherein the semiconductor layer of the thin film transistor is formed of an organic compound, and
wherein the source electrode of the thin film transistor has a function of pixel electrode and is disposed between the one of the substrates and the first alignment layer, and the first alignment layer is formed in a planar region other than an upper area of the semiconductor layer.

5. The liquid crystal display device according to claim 1, wherein the first alignment layer is polyimide, polyamic acid, or a film consisting of polyimide and polyamic acid.

6. The liquid crystal display device according to claim 1, wherein the gate insulating layer and the first alignment layer are formed of the same material.

7. The liquid crystal display device according to claim 1, wherein
the semiconductor layer is formed of a liquid crystalline material, and
the gate insulating layer in contact with the semiconductor layer is subjected to an alignment process.

8. The liquid crystal display device according to claim 7, wherein a surface of the gate insulating layer in contact with the semiconductor layer is subjected to an alignment process in a direction from where the source electrode is formed toward where the drain electrode is formed or in a direction from where the drain electrode is formed toward where the source electrode is formed.

9. The liquid crystal display device according to claim 7, wherein an alignment direction formed on a surface of the gate insulating layer in contact with the semiconductor layer and an alignment direction formed on a surface of the alignment layer are not coincident with each other.

10. The liquid crystal display device according to claim 1, wherein a color filter is included between the other of the substrates and the second alignment layer.
